(19) United States
(12) Patent Application Publication
(10) Pub. No.: US 2020/0372764 A1
(43) Pub. Date: Nov. 26, 2020

(54) MULTI-EVENT, MULTIPLE-BET TYPE TOURNAMENT-STYLE WAGERING SYSTEM AND METHOD

(71) Applicant: Gregory A. Brauser, Boca Raton, FL (US)

(72) Inventor: Gregory A. Brauser, Boca Raton, FL (US)

(21) Appl. No.: 16/881,432

(22) Filed: May 22, 2020

Related U.S. Application Data
(60) Provisional application No. 62/851,473, filed on May 22, 2019.

(51) Int. Cl. G07F 17/32

(52) U.S. Cl. CPC G07F 17/3288; G07F 17/3276; G07F 17/3246; G07F 17/3223

(57) ABSTRACT

A multi-game, multi-sport, and multi-bet type tournament-style wagering system and method where bettors participate as entrants in a wagering tournament that is carried out over a pre-determined amount of time and establishes a pre-determined entrance fee and a pre-determined prize amount. The tournament makes available a set of predetermined events on which the bettors can place wagers. Within each event, the bettor can place any number of wagers of any desired and available bet type, provided the bettor has enough remaining credits to satisfy the required size of the selected wager. The system permits bettors to continue placing wagers on events that have not begun, and thus are active, even though other events, and their corresponding wagers, are inactive.

### CROSS-REFERENCE TO RELATED APPLICATIONS

This application is a non-provisional application, and claims priority benefit of U.S. Provisional Patent Application Ser. No. 62/851,473 filed May 22, 2019, which is incorporated herein by reference in its entirety

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure invention and is not meant to limit the inventive concepts disclosed herein.

The accompanying drawings, which are incorporated in and constitute a part of the specification, illustrate embodiments of the disclosure and together with the general description of the disclosure given above and the detailed description of the drawings, given below, explain the principles of the disclosure.

In the drawings:

FIG. 1 is a system environment, according to an embodiment.

FIG. 2 describes a method for using the wagering system, according to an embodiment.

FIG. 3 describes a method for using the wagering system, according to another embodiment.

FIGS. 4-6 depict embodiments of the GUI/UX of the wagering system

FIG. 7 is a computing environment, according to an embodiment.

The drawings are not necessarily to scale. In certain instances, details that are not necessary for an understanding of the disclosure or that render other details difficult to perceive may have been omitted. It should be understood, of course, that the disclosure is not necessarily limited to the embodiments illustrated herein.

### DETAILED DESCRIPTION

The present invention provides its benefits across a broad spectrum of endeavors. It is applicant's intent that this specification and the claims appended hereto be accorded a breadth in keeping with the scope and spirit of the invention being disclosed despite what might appear to be limiting language imposed by the requirements of referring to the specific examples disclosed. Thus, to acquaint persons skilled in the pertinent arts most closely related to the present invention, a preferred embodiment of the system is disclosed for the purpose of illustrating the nature of the invention. The exemplary method of installing, assembling and operating the system is described in detail according to the preferred embodiment, without attempting to describe all the various forms and modifications in which the invention might be embodied. As such, the embodiments described herein are illustrative, and as will become apparent to those skilled in the art, can be modified in numerous ways within the scope and spirit of the invention, the invention being measured by the appended claims and not by the details of the specification.

Although the following text sets forth a detailed description of numerous different embodiments, the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, subparagraph (f).

### Definitions

The present invention relates to a multi-game and, in some embodiments, multi-sport and multi-bet type tournament-style wagering system and method. As such, for purposes of this disclosure, it is helpful to present and define certain material terms relevant in the art of wagering and, more specifically, sports wagering. Capitalized terms used herein, and terms not otherwise defined herein shall have the meanings set forth below:

“Bet” or “Wager” means an act of risking, a sum of money (or money proxies) on the outcome of a future event or combination of future events.

“Bet Type” means if Bet, Moneyline Bet, Parlay Bet, Proposition Bet, Spread Bet, Teaser Bet, or Total Bet.

“Event” means a bettable occurrence characterized by having a pre-determined beginning and end. Events can comprise, without limitation, sporting events, political elections, stocks, financial futures that may take place in the immediate or distant future, or that may currently be ongoing.

“If Bet” means a Wager comprising at least two straight Wagers joined together by an if clause which determines the wager process. If the player's first Wager complies with the condition (clause), then the second Wager will have action; if the second Wager complies with the condition, then the third Wager will have action and so on.

“In-play Wager” means a Wager of any type placed on an Event while that sporting Event is in progress.

“Moneyline Bet” means a Wager on a specific team, party, side, or selection to win the Event outright. A Moneyline Bet does not have a Spread or handicap and requires the chosen side to win the Event outright. The favored side pays lower odds than does the underdog, thus, it acts mainly as an enticement to take the underdog for a better payout.

“Parlay Bet” means a single Wager that combines multiple Wagers that rewards successful bettors with a greater payout only if all Wagers in the parlay win. A parlay is at least two Wagers but can be as many as the bookmaker will allow. The possible payout of the Parlay is determined by the combined likelihood of all Wagers placed. A Parlay of riskier Wagers (more underdogs) will pay greater than a Parlay of more likely Wagers (more favorites). In a Parlay, all Wagers need to win for the Parlay to win. If one of the Wagers in a Parlay loses, the whole Parlay loses. In the event of a push, the pushed Wager would be taken out of the Parlay and the Parlay would bump down to a set of odds without that Wager. Parlays are very appealing to bettors because dollar-for-dollar they are less risky than straight Wagers.

“Proposition Bet” or “Prop Bet” means a Wager made on a very specific outcome of an Event not related to the outcome or winner/loser of the Event, usually of a statistical nature. Examples include predicting the number of goals a star player scores in an association football match, betting whether a player will run for a certain number of yards in an American football game or wagering that a baseball player on one team will accumulate more hits than another player on the opposing team.

“Spread Bet” means a Wager made against the Spread. The favorite “takes” points from the final score and the underdog “gives” points.

“Spread” means a set amount of points determined by the oddsmaker that the favorite gives or the underdog takes as a handicap to make the game more even.

“Teaser Bet” is a Parlay that gives the bettor an advantage at a lower, but still positive, payout if successful. The bettor selects the number of Events and number of points given. For example, if the bettor takes two games at +6.5 it will adjust the individual bets at that rate. So, a bet on a 3-point underdog at +3 will become a bet at 9.5 points, and for favorites; it will change a 3-point favorite at −3 to +3.5 points. Although the rules to win bet are the same as a parlay, the bettor is paid less than a regular parlay due to the increased odds of winning.

“Total Bet” or “Over/Under Bet” means a Wager made based on the total score between both teams where the Event is a head-to-head sporting event. Example, if a game has a total of 10.5, an over bettor will want the combined total to be greater, and the opposite for a bettor taking the under. If the combined total is the same as the proposed total, the Bet is a push (tie).

Wagering Method

Broadly described, the present invention comprises various embodiments of a wagering method whereby two or more bettors participate as entrants in a wagering tournament (“Tournament”). The wagering tournament is carried out over a pre-determined amount of time (“Duration”) and establishes a pre-determined entrance fee (“Buy-In”) and a pre-determined prize amount (“Prize”). Before the Tournament begins, each bettor is assigned credits with which to place Wagers (“Credits”). The Credits may or may not correspond to the value of the Buy-In, In some embodiments, each bettor pays the same Buy-In and is assigned the same number of Credits as every other bettor in the applicable tournament. The Prize may comprise all or a portion of the aggregate Buy-In of all bettors. In some embodiments, a Prize is awarded to multiple bettors based on how the bettors place in the standings of the Tournament at the end, or at some other pre-determined time during the Tournament.

The Tournament makes available a plurality of predetermined Events on which the bettors can place Wagers. Within each Event, the bettor can place any number of Wagers of any desired and available Bet Type, provided the bettor has enough remaining Credits to satisfy the required size of the selected Wager. In some cases, the Wager size is predetermined, and, in other cases, the bettor is free to select the Wager size as desired up to the maximum remaining Credits available to the bettor.

The bettors compete amongst themselves, rather than against the “house,” in a tournament-style fashion. Throughout the course of the Tournament, the outcome of each Wager is determined upon the settling of each such Wager. If the bettor wins the Wager, the better is “paid out” in Credits according to the applicable odds for such Wager. The odds are set by a Tournament administrator and may be obtained from a wagering data service bureau. If the bettor loses the Wager, the Credits placed on such Wager are lost and disappear from the system. In other words, any lost Credits are gone, no longer available to the bettor that placed the losing Wager or any other bettor. The goal for each bettor is to achieve the highest number of possible Credits by the settlement of all Events within the Tournament and the close of the Duration thereof.

Throughout the course of the Tournament, bettors may continue to place Wagers of any available Bet Type on any Events that are “on” or active. An Event is “off” or inactive, and thus no Wagers can be placed thereon, once the Event begins. In the context of sports wagering, typically the Event is inactive following kickoff, tipoff, puck drop, or otherwise after the sporting event begins play. Notably, however, the present invention permits bettors to continue placing Wagers on Events that have not begun, and thus are active, even though other Events, and their corresponding Wagers, are inactive. This adds a significant element of strategy to the Tournament because the bettor can place new bets on different Events (provided such Events are “on”) throughout the course of the Tournament in order to try to gain ground on the leaders, or to extend one's lead on the pool of contestants.

The ability to continue placing Wagers on “on” or active Events even though other Events are “off” or inactive is a form of Tournament-level “in-play” wagering heretofore not conceived. For clarity and comparison, the term “in-play” betting typically refers to placing wagers on a single game while that game is in progress. For example, in the middle of the second quarter of a football game, and with the knowledge of how well or poorly the teams are playing relative to one another, the bettor places a wager on the final score. In present invention, however, the method provides macro-level “in-play” wagering wherein the bettor can continue to place new Wagers on active Events while the multi-Event tournament is still in progress, with various Events inactive and various Events active. This macro-level in-play wagering, in combination with the ability to place Wagers of multiple Bet Types provides a method and system that requires a substantially high level of strategy as compared to other methods known in the art.

Wagering System and Network-Enabled Platform Host

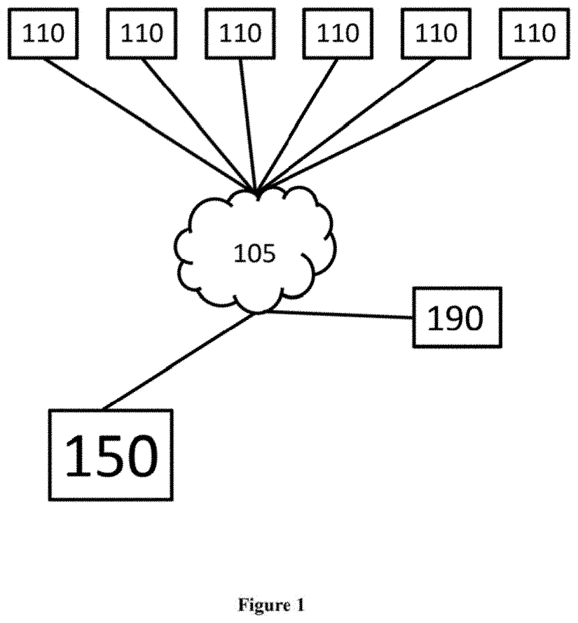

FIG. 1 illustrates one embodiment of an information system that facilitates management and execution of the wagering methods described herein. The system includes a one or more bettor devices 110 that bettors use to communicate with the at least one system platform host 150. The bettor devices 110 and the host 150 are in communication over a communications network 105 such that the bettor device 110 can access the host 150 to send and receive data thereto and therefrom. In some embodiments, the host 150 is in communication with a wagering data service bureau 190, also over communications network 105. The information system, in some embodiments, comprises an internet-enabled computing system whereby the bettor devices 110 access an online community and internet-based platform served by the platform host 150 which facilitates and carries out the wagering method described herein.

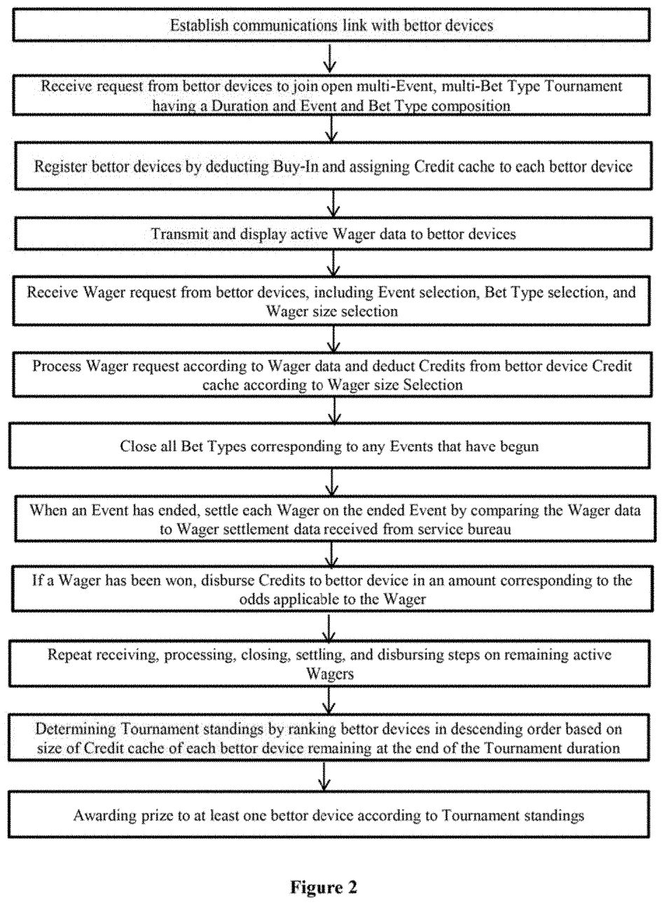

With reference to FIG. 2, shown are the method steps from the perspective of the platform host 150 according to one embodiment. A communications link is established between a plurality of bettor devices 110 and the platform host 150. The platform host 150 receives a request from two or more bettor devices 110 to join an open Tournament. The Tournament makes available a plurality of Events on which the bettors can place a Wager of at least one Bet Type. The Tournament is characterized by a predetermined Duration and a predetermined composition of Events and Bet Types with respect to such Events. In some embodiments, the Duration of the Tournament is concluded upon the end or completion of the last Event in the Tournament.

The platform host 150 registers the bettor device 110 as a valid participant in the Tournament by accepting the Buy-In from each bettor device 110. The platform host 150 assigns to each bettor a predetermined Credit cache. The platform host 150 transmits and displays to each bettor device 110 Tournament data, including Prize data and active wager data, including odds data received from the wagering data service bureau 190.

To process Wagers, the platform host 150 receives one or more Wager requests from at least one bettor device 110 corresponding to a Wager of any Bet Type made on at least one Event. The Wager request includes the selected Event, the selected Bet Type, and a Wager size corresponding to the number of Credits the bettor device associates with the Wager. The platform host 150 processes the Wager request according to the Wager data (including odds information) and confirms at least one Wager by deducting Credits from the bettor device's Credit cache. Once a Event has begun (in real life), the platform host closes and renders inactive the Event and all associated Bet Types.

When an Event (or Bet Type within an Event, for example a Prop Bet) has ended, the platform host 150 settles the Wagers corresponding to such Event by receiving from the wagering data service bureau Wager settlement data corresponding to the result of the ended Event (or Bet Type within the Event). The platform host 150 compares the Wager settlement data to the Wager request to determine whether the Wager has been won, lost, or pushed (tied). If the Wager is won, the platform host 150 disburses to the bettor device 110 Credits corresponding to the odds of the applicable Wager. If the Wager is lost, the Credits associated with the Wager are lost and disappear from the system. If the Wager is a push (tie), the Credits associated with the Wager are refunded to the bettor device 150.

The platform host 150 then repeats the Wager receiving, wager processing, Event closing, and Wager settlement steps on all remaining active Events until completion of the Tournament Duration. In this way, the better device 110 can continue to place Wagers on active Events even if other Events are closed and inactive. Upon completion of the Tournament, the platform host 150 determines Tournament standings by ranking the bettor devices in descending (high to low) order according to the amount of Credits each bettor device has at the end of the Tournament. In some embodiments, the platform host 150 continually ranks the bettor devices based on Credit cache size in real-time upon the closing of each Event (or Bet Type within each Event, if applicable). The Prize is then awarded to at least one bettor device. In some embodiments, the Prize corresponds to all or a portion of the Buy-In, in some cases subject to a commission or fee charged by the platform host 150.

Graphical User Interface and User Experience

The present invention also provides graphical user interface (“GUI”) and user experience (“UX”) which facilitates the operational characteristics of the wagering system and method described herein. In some embodiments, the GUI is provided by way of a software application running on the bettor device 110. In other embodiments, the GUI is provided by way of a website accessible through a web browser running on the bettor device 110. In both instances, the GUI is served to the bettor device 110 by the platform host 150, typically by way of the communications network 105.

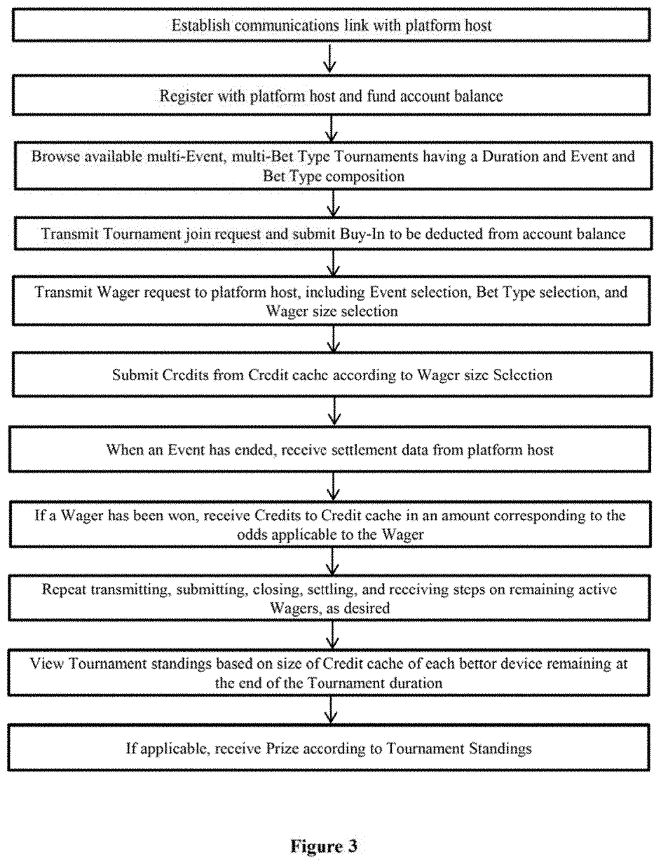

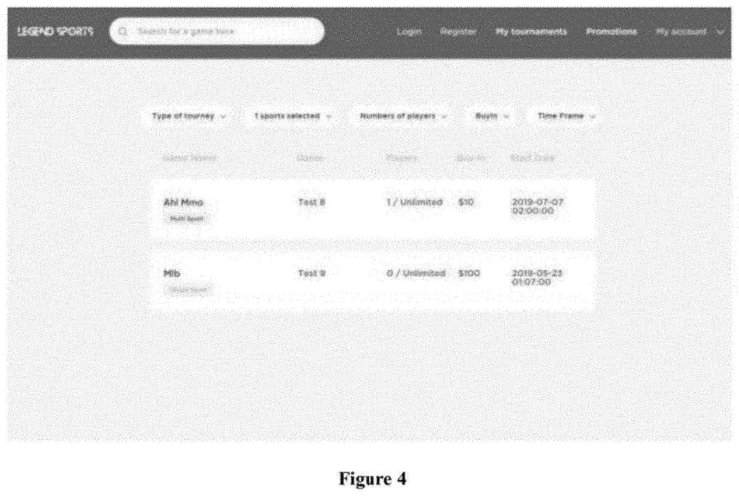

FIG. 3 shows the method steps through which the bettor device 110 interacts with the GUI/UX provided by the platform host 150. FIGS. 4-6 provide exemplary screen shots of the GUI/UX as it pertains to the method and system shown and described herein. The bettor device 110 accesses the homepage (FIG. 4) and creates an account by registering with the platform host 150. Through the GUI, the bettor device 110 transmits registration information to the platform host 150 including name, username, e-mail address, date of birth, billing address, password, and payment information. Once the bettor device 110 has established an account, the bettor device 110 can then submit an electronic payment to establish or replenish an account balance from which to draw Buy-In funds.

Through the homepage, the bettor device 110 can browse for Tournaments according to various modifiers including type of Tournament, number of Event types, number of players, the Buy-In amount, and the Duration. The bettor device 110 can sort and view the various available Tournaments by using a series of drop-down menus.

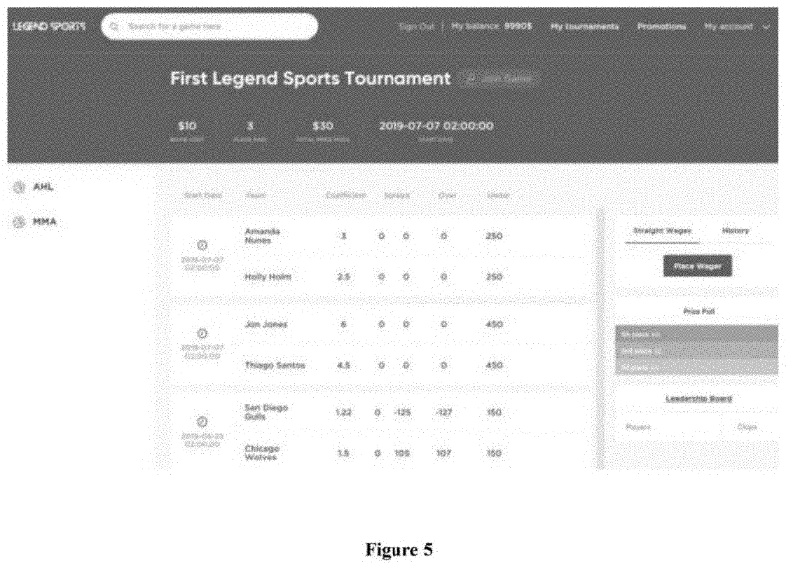

The bettor device 110 begins the Tournament entry process by clicking on a Tournament and navigating the Tournament page (FIG. 5). Here, the better device 110 receives and views Tournament information such as the Buy-In, the Prize, the pay-outs by ranking, the start date, and the Duration. The bettor device 110 can formally join the Tournament by clicking the appropriate function, which transmits a Tournament join request to the platform host 150. In doing so, and provided the bettor device's account balance contains sufficient funds, the bettor device 110 submits a Buy-In request to the platform host 150 which deducts funds from the bettor device 110 account balance in an amount equal to the Tournament Buy-In. The bettor device 110 then receives the pre-determined Credit cache with which to place Wagers.

At this point, the bettor device 150 can begin to create and submit Wagers on any available active Event and Bet Type. The bettor device 110 access the central portion of the Tournament page, which presents a list of actives Events along with various Bet Types and the relevant odds, for example the Moneyline, the Spread, and the Total. The bettor device 110 can also selectively sort the available Events using the left-hand frame, by which the bettor device 110 can toggle the display of Events by Event type, such as league, or sport.

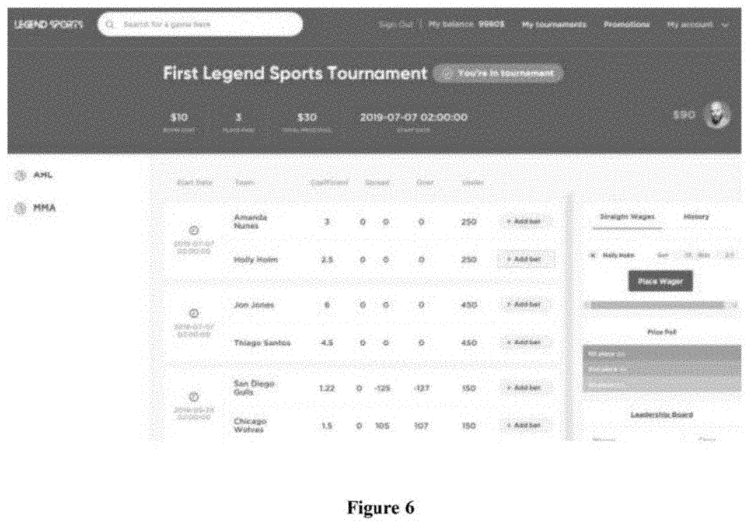

With reference to FIG. 6, the bettor device 110 places a Wager by clicking on the Event. This populates a betting ticket on the right-hand frame which allows the bettor device 110 to select the Bet Type and Wager size. The bettor device 110 can select multiple Events and sub-combinations of Bet Types in order to create Parlays, Teasers, and other combination-based Bet Types. The bettor device 110 confirms a Wager by click the “Place Wager” or similar button at which point the bettor device 110 transmit a Wager requests which formalizes the Wager and transmits to the platform host 150 Credits from the Credit Cache in an amount equal to the entered Wager size.

Upon commencement of the Tournament and for the remainder of the duration thereof, the bettor device 110 can continue to submit and confirm Wager requests on any active Event and associated Bet Types, provided the Credit cache of the bettor device 110 has enough funds. Wagers can continue to be placed on active Events regardless of whether certain other Events are inactive.

Throughout the Duration of the Tournament, the bettor device 110 will receive settlement data from the platform host 150 relating to whether the bettor device 110 has won, lost, or pushed a given Wager. Additionally, the bettor device 110 will receive and can view standings and rankings information pertaining to the performance of Wagers with relationship to other bettor devices 110 in the Tournament. At the end of the Tournament, each bettor device 110 will receiving final standing information and, if a bettor device 110 places in the rankings, the bettor device 110 will receive a Prize to be credited to the applicable account balance of the bettor device 110.

Social and Other Features of Platform

It is appreciated and understood that the present system and method may be embodied by one or more software applications or websites. Within such applications or website environments, the system may include various social features including the ability to chat, direct message, and post text, photographs, or other content. Additionally, the platform may include Tournament creation functionality that permits the bettor devices 110, i.e. users, to create and manage their own private or public tournaments. This Tournament creation functionality may run side-by-side with administrator-created Tournaments or automatic (AI)-created Tournaments. In creating such Tournaments, users can set preferences including Tournament size and Event and Bet Type composition.

Explanation of Computing Environment

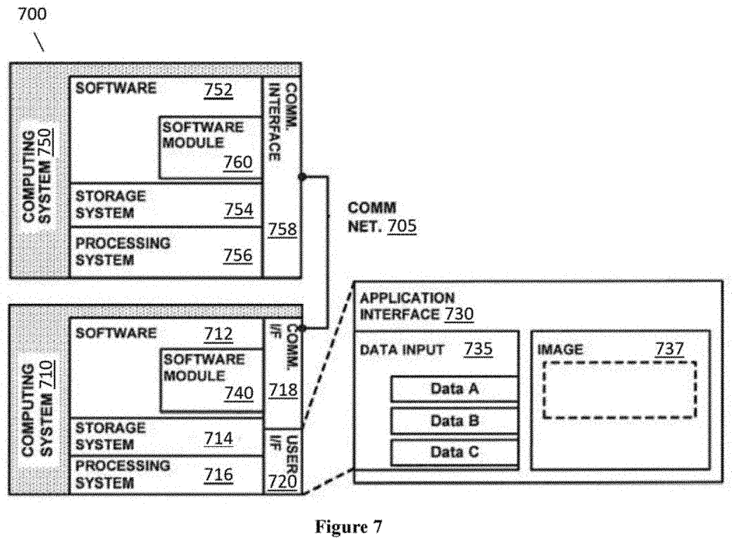

FIG. 7 illustrates a computing environment 700 according to one embodiment. Computing environment 700 includes computing system 710 and computing system 750. Computing system 710, in the present example, corresponds to bettor devices 110 that can send and receive data and information, and computing system 750 corresponds to system platform host 150 that can also send and receive data and information. Computing system 710 can include any smart phone, tablet computer, laptop computer, or other computing or mobile device capable of reading, and/or recording data about systems, devices, locations, and/or equipment, etc. Computing system 750 can include any server computer, desktop computer, laptop computer, or other device capable of storing and managing data communication by and between one or more computing systems 710 and the wager data service bureau 190 and other similar computing systems. Either system 710 or 750 can be capable of accomplishing any of the steps of functions described in this description.

In FIG. 2, computing system 710 includes processing system 716, storage system 714, software 712, communication interface 718, and user interface 720. Processing system 716 loads and executes software 712 from storage system 714, including software module 740. When executed by computing system 710, software module 740 directs processing system 716 to receive data, images, devices, locations, and/or equipment, etc. Such data could include any of the information described above, including but not limited to the functionality described herein.

Although computing system 710 includes one software module in the present example, one or more modules could provide the same operation. Similarly, the computing systems may be distributed using other computing systems and software.

Additionally, computing system 710 includes communication interface 718 that can be further configured to transmit data to and receive data from computing system 750 using communication network 705 (which represents the communications network 105 show in FIG. 1). Communication network 705 could include the Internet, cellular network, satellite network, RF communication, blue-tooth type communication, near field, or any other form of communication network capable of facilitating communication between computing systems 710 and 750.

Referring still to FIG. 7, processing system 716 can comprise a microprocessor and other circuitry that retrieves and executes software 712 from storage system 714. Processing system 716 can be implemented within a single processing device but can also be distributed across multiple processing devices or sub-systems that cooperate in executing program instructions. Examples of processing system 716 include general purpose central processing units, application specific processors, and logic devices, as well as any other type of processing device, combinations of processing devices, or variations thereof. Storage system 714 can comprise any storage media readable by processing system 716, and capable of storing software 712. Storage system 714 can include volatile and nonvolatile, removable and non-removable media implemented in any method or technology for storage of information, such as computer readable instructions, data structures, program modules, or other data. Storage system 714 can be implemented as a single storage device but may also be implemented across multiple storage devices or sub-systems. Storage system 714 can comprise additional elements, such as a controller, capable of communicating with processing system 716.

Application interface 730 can include data input 735 and image display 737. In one example, data input 735 can be used to collect information and data inputs from the user. It should be understood that although computing system 710 is shown as one system, the system can comprise one or more systems to collect data.

Computing system 750 includes processing system 756, storage system 754, software 752, and communication interface 758. Processing system 756 loads and executes software 752 from storage system 754, including software module 760. When executed by computing system 750, software module 760 directs processing system 710 to store and manage the data from computing system 710 and other similar computing systems. Although computing system 710 includes one software module in the present example, it should be understood that one or more modules could provide the same operation.

Additionally, computing system 750 includes communication interface 758 that can be configured to send and receive data to and from computing system 710 and/or wagering data service bureau 190 using communication network 705.

Referring still to FIG. 7, processing system 756 can comprise a microprocessor and other circuitry that retrieves and executes software 752 from storage system 754. Processing system 756 can be implemented within a single processing device but can also be distributed across multiple processing devices or sub-systems that cooperate in executing program instructions. Examples of processing system 756 include general purpose central processing units, application specific processors, and logic devices, as well as any other type of processing device, combinations of processing devices, or variations thereof.

Storage system 754 can comprise any storage media readable by processing system 756, and capable of storing software 752 and data from computing system 710. Data from computing system 710 may be stored in a word, excel, or any other form of digital file. Storage system 754 can include volatile and nonvolatile, removable and non-removable media implemented in any method or technology for storage of information, such as computer readable instructions, data structures, program modules, or other data. Storage system 754 can be implemented as a single storage device but may also be implemented across multiple storage devices or sub-systems. Storage system 754 can comprise additional elements, such as a controller, capable of communicating with processing system 756.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. In no case is the storage media a propagated signal.

In some examples, computing systems 710 and 750 an include a user interface. The user interface can include a mouse, a keyboard, a voice input device, a touch input device for receiving a gesture from a user, a motion input device for detecting non-touch gestures and other motions by a user, and other comparable input devices and associated processing elements capable of receiving user input from a user. Output devices such as a graphical display, speakers, printer, haptic devices, and other types of output devices may also be included in the user interface. The user input and output devices are well known in the art and need not be discussed at length here.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the present disclosure has included description of one or more embodiments and certain variations and modifications, other variations and modifications are within the scope of the disclosure, e.g., the use of a certain component described above alone or in conjunction with other components may comprise a system, while in other aspects the system may be the combination of all of the components described herein, and in different order than that employed for the purpose of communicating the novel aspects of the present disclosure. Other variations and modifications may be within the skill and knowledge of those in the art, after understanding the present disclosure. This method of disclosure is intended to obtain rights which include alternative embodiments to the extent permitted, including alternate, interchangeable and/or equivalent structures, functions, ranges or steps to those claimed, whether such alternate, interchangeable and/or equivalent structures, functions, ranges or steps are disclosed herein, and without intending to publicly dedicate any patentable subject matter.

What is claimed is:

1. A method of facilitating a multi-Event, multi-Bet Type wagering tournament, comprising:
a. On a platform host, establishing a communications link with a plurality of bettor devices;
b. Receiving from the bettor devices a join request with respect to a multi-Event, multi-Bet Type wagering Tournament;
c. Registering the requesting bettor devices into the Tournament by deducting a Buy-In from an account balance associated with each of the bettor devices;
d. Assigning to the registered bettor devices a credit Cache;
e. Transmitting and displaying to the bettor devices active Wager data relating to a plurality of active Events on which a Wager can be placed;
f. Receiving from at least one bettor device a Wager request including Event selection, Bet Type selection, and Wager size selection;
g. Processing the Wager request by deducting from the credit Cache of the applicable bettor device Credits equal to the Wager size;
h. Closing all Bet Types corresponding to any Events that have commenced;
i. When an applicable Event has ended, settling each Wager on the ended Event by comparing the Wager request to Wager settlement data received from a service bureau;
j. Disbursing Credits to any bettor device for which a Wager has been one, the Credits corresponding to odds applicable to the Wager;
k. Repeating steps E through J on all remaining active Wagers until completion of a pre-determined Duration of the Tournament;
l. Determining, at the end of the Tournament Duration, Tournament standings by ranking bettor devices in descending order according to the size of the Credit cache of each bettor device; and
m. Awarding a Prize to at least one bettor device according to the Tournament standings.

2. The method of claim 1, wherein the Bet Type comprises an If Bet, a Moneyline Bet, a Parlay Bet, a Proposition Bet, a Spread Bet, a Teaser Bet, a Total Bet, or combinations thereof.

3. The method of claim 1, wherein the plurality of active Events comprises sporting events.

4. The method of claim 1, wherein the plurality of active Events comprises political elections.

5. The method of claim 1, wherein the plurality of active Events comprises stock trading.

6. A method of facilitating a multi-Event, multi-Bet Type wagering tournament, comprising:
a. On a bettor device, establishing a communications link with a platform host;
b. Registering with the platform host and establishing an account balance;
c. Browsing available multi-Event, multi-Bet Type Tournaments each having a Duration and a pre-determined Event and Bet Type composition;
d. Transmitting to the platform host a Tournament join request and submitting a Buy-In to be deducted from the account balance;
e. Transmitting to the platform host a Wager request including Event selection, Bet Type Selection, and Wager Size selection;
f. Submitting to the platform host Credits from a Credit cache according to the Wager Size selection;
g. When an Event has ended, receiving from the platform host settlement data pertaining to whether an applicable Wager has been won, lost, or pushed;
h. If an applicable Wager has been won, receiving Credits to the Credit cache in an amount corresponding to the odds applicable to the Wager;
i. Repeating steps E through H on all remaining active Wagers until completion of a pre-determined Duration of the Tournament;
j. Viewing Tournament standings based on the size of the Credit cache of each bettor device remaining at the end of the Tournament duration;
k. If applicable, receiving on a winning bettor device a Prize according to the Tournament standings.

7. The method of claim 6, wherein the Bet Type comprises an If Bet, a Moneyline Bet, a Parlay Bet, a Proposition Bet, a Spread Bet, a Teaser Bet, a Total Bet, or combinations thereof.

8. The method of claim 6, wherein the plurality of active Events comprises sporting events.

9. The method of claim 6, wherein the plurality of active Events comprises political elections.

10. The method of claim 6, wherein the plurality of active Events comprises stock trading.
